(19) United States
(12) Patent Application Publication
(10) Pub. No.: US 2006/0241952 A1
(43) Pub. Date: Oct. 26, 2006

(54) Online multidisciplinary collaborative divorce system

(76) Inventor: Michael A. Loduha, Oostburg, WI (US)

Correspondence Address: Michael Loduha;Law Offices of Michael Loduha, 1332 South 26th Street, Manitowoc, WI, 54220, US

(21) Appl. No.: 11/110,627

(22) Filed: Apr. 20, 2005

(51) Int. Cl. G06Q 99/00; H04L 9/00; H04K 1/00

(52) U.S. Cl. 705/1; 705/80

(57) ABSTRACT

An online system providing an internet-based programmed application service in support of multidisciplinary collaborative divorce proceedings. The system includes an interactive introduction web page for viewing and entering information identifying the divorce proceeding and the parties involved including a bulletin board for viewing and entering short messages, an interactive information web page for viewing and entering factual information relating to the divorce proceedings including the status of relationships and financial and property data and an interactive critical path web page for viewing and entering critical path information about the issues and procedures for resolving the issues, and an interactive scheduling web page including a calendar for viewing information about the timeline of events affecting the proceeding and for entering information about new events

### BACKGROUND

The present invention relates to online systems for promoting collaborative activities and more particularly for internet-based systems for administering, supporting and facilitating multidisciplinary collaborative family law activities.

The adversarial system of litigation in the courts does not always serve the best interests of couples going through divorce proceedings. In many cases the adversarial system can make an unfortunate situation worse and turn people whose lives were growing apart first into adversaries and then into enemies encouraged to try to get what is best for them regardless of the consequences for others including their own children. Litigation is necessary when people can't work out their own problems but is often a very inefficient way to resolve most problems. Resolving issues in this manner can consume hours and hours of time and large amounts of resources. The system often drains the emotional and financial life out of the divorcing spouses it was supposed to try to help and turns into a divisive and painful experience for all who are involved. The adversarial system often comes to control the parties rather than allowing the parties to control their divorce and the course of their own lives. The attorneys for the parties are likewise trapped by the nature of the system and many often share the acute disappointment and frustration experienced by many of their clients.

Marriage has always had two separate and distinct aspects. One element is private and personal to the spouses. Within this aspect is found the elements that relate to the spouses as individuals and include such things as the emotional and rational satisfaction of each in their relationship with the other. The other aspect of marriage is legal and public. Here we find the elements of the relationship of the spouses, individually and jointly with the rest of society. This aspect contains such things as Social Security benefits attached to marital status (an example of rights relating to the government predicated on marriage), homestead rights in real estate (an example of rights binding third parties in private contracts) and/or responsibility for reciprocal medical care and support (an example of responsibilities to third parties imposed by virtue of the marriage). In addition there are rights and responsibilities of the spouses each to the other that will be enforced by the courts after the spousal relationship ends, such as alimony.

Over the last several decades, not only has the expectations of the private and personal relationship between the spouses changed but the public aspects of this socio-legal relationship between individuals called marriage have undergone significant changes as well. These changes have included an increasing emphasis on the rights of each individual compared to the responsibilities of the spouses associated with the social expectations of marriage. Simply put, marriage has become more ‘rights driven’ both in its inception and its dissolution.

The dissolution of the public part of marriage has always been the province of our common law court system. This system has always depended on two specific components to facilitate its functionality in society. They are its coercive authority and its universality. The coercive authority of the common law courts means two things; first that once the parties to the dispute are under the authority of the court, it is the court's determination, and not their agreement with that determination, which counts. The second flows from the first. Society has determined that the courts shall have the power to enforce its decisions, by force if necessary, even when the decision only affects the parties privately. The universality component of the common law court system means that in determining the outcome to any particular dispute, the court applies to the each individual situation (the facts) standards (the law) that apply to everyone similarly situated.

Changing social mores and individual expectations have decreased the duration of the average marital relationship and conversely increased the number of dissolutions per unit population. Beginning several decades ago, our common law legal system became increasingly dysfunctional when applied to the dissolution of many marriages. A principal response was what is called ‘no fault’ divorce. This movement was essentially a bifurcation of the causes for the breakdown of the private component of the marital relationship from the exercise of the court's authority. However, this substantive bifurcation did not impact the court's procedural methodology, the adversarial processes collectively called litigation.

Changing expectations as to the rights and satisfaction of the individual spouses within marriage has increasingly made litigation a poor fit and an ineffective tool in the process of marital dissolution. Beginning in the 1990s a movement began away from litigation as the sole procedural method by which to dissolve marriage. A principle component of this movement, called collaborative family law, is the agreement by the spouses and their attorneys not to use the courts to determine any of the terms by which their marriage will end. Now free to consider a wider range of factors—primarily those from the private and personal aspect of marriage, collaborative family law addresses a much wider range of issues than can be considered by the court in litigation. Because the spouses eschew the confrontational and negative elements of litigation, the collaborative process results in much less emotional damage to the parties, and moreover less such damage to their children. Because some of the inherent inefficiencies of litigation are avoided, collaboration also does much less damage to the parties' present and future financial situation.

Collaborative family law carries within it two new areas of concern. First, the wider field of potentially relevant considerations takes the process outside the experience and expertise of most attorneys. Second, the absence of litigation removes the case critical path that the litigation model imposes on the spouses and their legal representatives. The first concern can dealt with by the inclusion of other professional disciplines in the process, such as mental health counselors, child welfare specialists or financial advisors. However, the inclusion of these disciplines within the collaborative process presents a separate set of challenges relating to the real time coordination between the various professionals. The other issue relates to the case-by-case development of individually crafted and mutually agreed alternatives to case critical paths defined by the litigation process. Meeting these needs, unique to the multidisciplinary collaborative dissolution of marriage, is an important challenge.

To help clients as people, the collaborative movement has structured proceedings to address the personal side involved in the process and help the whole client. The lawyers would provide help and guidance in the resolution of the public and legal parts of the divorce and, where needed or helpful, family therapists and other clinicians help clients as ‘coaches’ with the personal issues and changes. Collaborative divorce recognizes and structures proceedings based on the principles that reconciliation and peaceful resolution of the issues is the best outcome where such reconciliation represents the acceptance of the terms of a changing life circumstance, terms that the parties themselves collaborated in creating in a process founded on mutual respect and understanding.

Moreover, there are many hardheaded reasons to collaborate. It's much more efficient, faster and much cheaper. It's less stressful on the spouses and allows their lives to return to normal sooner. It promotes cooperation with respect to continuing custody and support issues. Further, it avoids the possibility of having something unwanted and unpleasant crammed down on the spouses by the court system.

Given the potential of collaborative divorce proceedings new systems need to be established that support collaborative divorce activities and assist in making them more convenient, more available to the public and more efficient.

### SUMMARY

The present invention provides a programmed system for providing an online internet-based application service in support of multidisciplinary collaborative divorce proceedings. The system includes an interactive introductory web page for viewing and entering introductory and identity related information including a bulletin board for viewing and entering short messages. The system also includes an interactive information web page for viewing and entering factual information. The system further includes an interactive critical path web page for viewing and entering critical path information. Finally, the system includes an interactive scheduling web page including a calendar for viewing and entering scheduling information.

This system provides online application services featuring processing for administering, supporting and assisting multidisciplinary collaborative divorce proceedings. These services include processes essential in collaborative divorce proceedings involving the viewing and entering of information identifying the divorce proceeding and the parties, lawyers and other advisors; the viewing and entering of factual information relating to the divorce proceedings including the status of relationships and financial and property data; the viewing and entering of critical path information about the issues and procedures for resolving the issues in the case; and the viewing of a case calendar showing a timeline of events affecting the proceeding and the entering of information about new events.

Key aspects of the system involve conducting online collaborative negotiations based on the interactive web pages and the presentations of information they provide including the relevant factual information, the critical issues and proposed pathways for their resolution along with the schedule of case events. The system provides the opportunity for interacting with all the other participants as factual information, outstanding issues, and pathways for issue resolution are viewed, revised and the issues moved forward step by step toward resolution in accordance with the pathways and procedures agreed upon and finally resolved.

The system also includes sets of templates for the potentially relevant information and critical path web page presentations. Critical path templates may include subject categories for highlighting remaining issues and providing event sequences to resolve them. Potentially relevant information templates may include subject categories for organizing the factual information such as other people involved, hot buttons for the wife, hot buttons for the husband, real property, personal property and financial liabilities.

It is an object of the present invention to provide an interactive online application service in support of collaborative divorce proceedings that can assist in making such proceedings faster, more effective and more efficient.

It is another object of the present invention to provide an online application service in which factual information about divorce proceedings can be interactively viewed and entered, information about issues in divorce proceedings and pathways toward their resolution can be interactively viewed and entered and timeline and event information related to divorce proceedings can be interactively viewed and entered.

It is a further object of the present invention to provide an interactive online service for use in conjunction with collaborative divorce proceedings that coordinates and enables the active participation of all the parties in defining the relevant information, identifying the key issues, defining pathways toward their resolution and moving these issues toward final resolution on a step by step basis.

### BRIEF DESCRIPTION OF THE DRAWINGS

FIG. 1 provides an overall diagrammatic view of the system of the present invention.

FIGS. 2a and 2b provide screen views of the website pages and for system log on (the home page) and for case entry in accordance with the present invention.

FIG. 3 provides a screen view showing the basic elements of the case information page for the present invention.

FIG. 4 provides a screen view showing the basic elements of the potentially relevant information page for the present invention.

FIG. 5 provides a screen view showing the basic elements of the case critical path page for the present invention.

FIG. 6 provides a screen view of the basic dialog box used for both editing and adding items for presentation on the potentially relevant information and case critical path pages in accordance with the present invention.

FIG. 7 provides a screen view showing the basic elements of the case timeline page for the present invention.

FIG. 8 provide a screen view of a dialog box for scheduling events in accordance with the present invention.

FIG. 9 provides a flow diagram illustrating the available sequences for receiving, exchanging, updating and inputting information in accordance with the system of the present invention.

### DETAILED DESCRIPTION

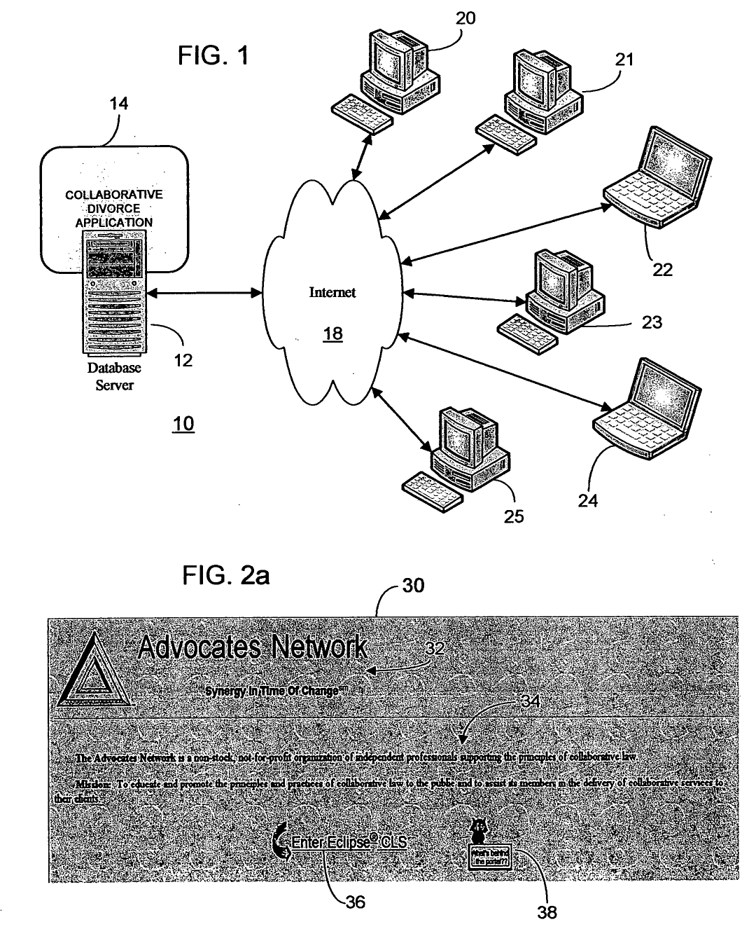

Referring now to FIG. 1, the system 10 includes a server 12 running a collaborative divorce software application 14 programmed for providing online collaborative divorce application services over the Internet 18. Collaborative divorce participants such as divorcing spouses, their lawyers and their other advisors and personal counselors use independent computers 20-25 running world wide web browser programs such as Internet Explorer by Microsoft Corporation of Redmond, Wash. to access the web site established by the collaborative divorce application 14. The computers 20-25 can log onto the collaborative divorce web site and open case files that their users are involved in by entering the correct case passwords for these cases. The case files include information populating a set of web pages that comprise the web site and the software application 14 and are designed to support and assist in the collaborative divorce process.

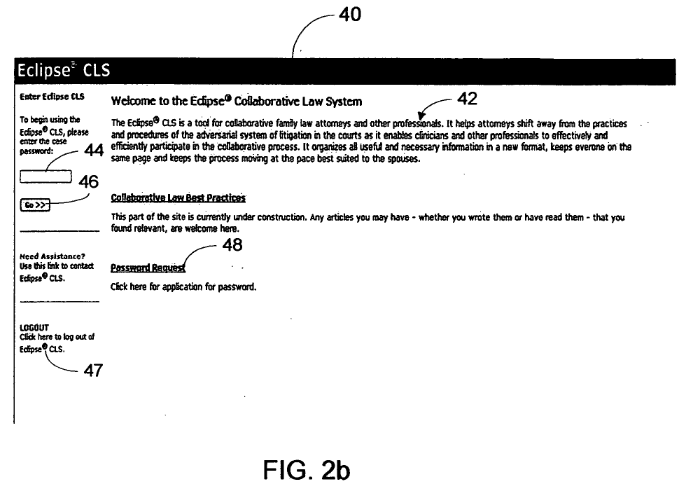

Referring now to FIGS. 2a and 2b the website home page 30 includes a title and logo 32, some introductory information 34 about the Advocates Network supporting the collaborative divorce movement and includes a system entry hot spot 36 entitled “Enter Eclipse CLS” (CLS for Collaborative Law System). The homepage 30 may also optionally include news announcements relating to the collaborative divorce web site and links to other topical web sites that may be of interest to the user. The user may also click on the hotspot 38 entitled “What's Behind The Portal??” for further information about the system and how to use it. The entry hotspot 36 which may be clicked on to bring up a conventional log in dialog box allowing for input of a user name and an associated password at text entry boxes. After entering correct user name and password and clicking a log in button the user is transferred case entry page 40 including further introductory information 42 about the collaborative divorce application 14 and the services it provides and also including a text entry box 44 for a case password allowing entry to case files. Case passwords are specific to each divorce case and are set up by communication with the staff running the application website which may be undertaken by clicking the password request hotspot 48. Upon entry of a valid case password and clicking the go button 46 the user is transferred to a case information web page 50 from where all the other web pages and resources associated with the application 14 may be accessed. Alternatively, the user can log off by clicking the button log out button 47 in order to exit the website all together.

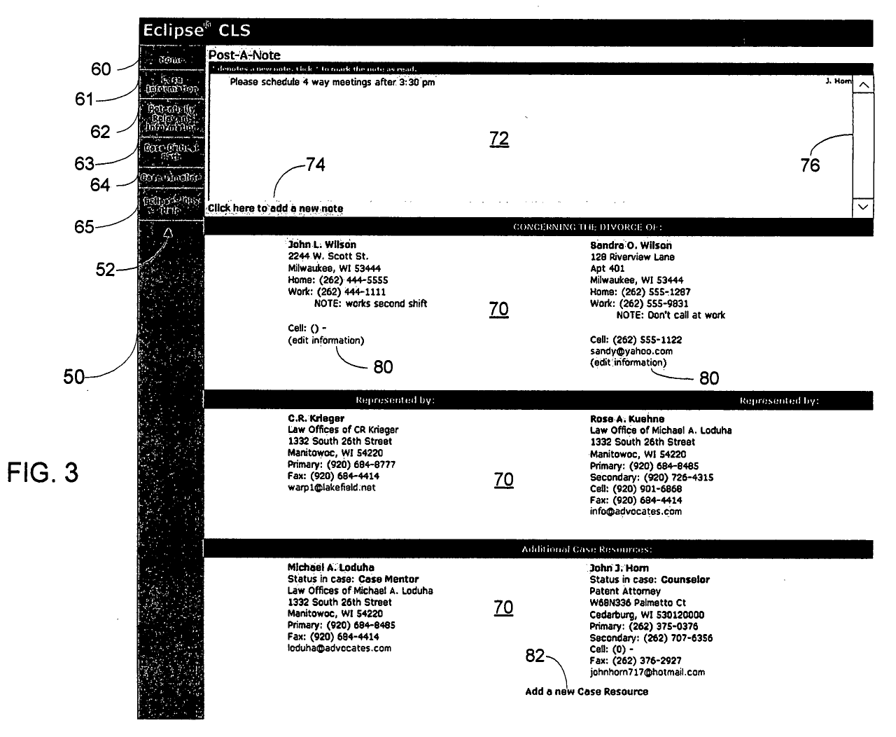

Referring now to FIG. 3, the Case Information page 50 includes a bank 52 of contiguous, vertically aligned, square-shaped quick link buttons 60-65 including a home (page) button 60, a case information button 61, a potentially relevant information button 62, a case critical path button 63, a case timeline page button 64 and an application help page button 65. The buttons 60-65 reside along the left hand border of the information page and may be clicked on to immediately transfer the user to these other web pages which are part of the application 14. The Case Information page 50 includes and presents basic information 70 identifying the spouses, lawyers and other advisors and counselors participating in the proceedings. The case information page 50 also includes a medium sized Post-A-Note text viewing box 72 with a scrolling bar 76 for viewing and posting brief notes and announcements of general interest to the participants. New notes can be entered by clicking the add a new note hotspot 74 which invokes a conventional one line text entry box that overlaps with the viewing box 72 and into which the note can be typed and then added to the existing notes already populating the box 72. The Case Information page 50 also includes edit information hotspots 80 which may be clicked on to invoke a conventional dialog box for editing or adding identification and contact information such as names, address, telephone numbers and email addresses for the divorcing spouses and an add a new case resource hot spot 82 which may be clicked on to invoke conventional dialog boxes for adding information such as names, address, telephone numbers and email addresses identifying new case resources such as lawyers, financial advisors, and personal counselors for participation in the proceedings in support of the divorcing spouses and their dependents. The dialog boxes for adding additional case resources preferably include lists that can be searched or scrolled showing approved network members registered on the website who would be available and agreeable for participation in collaborative divorce proceedings.

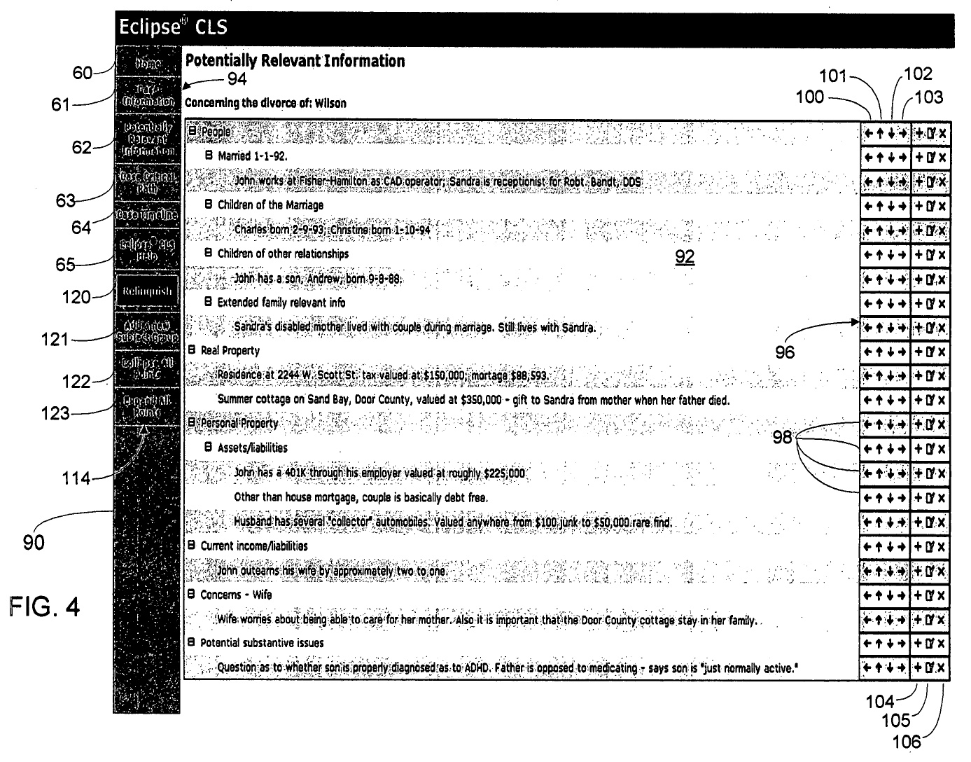

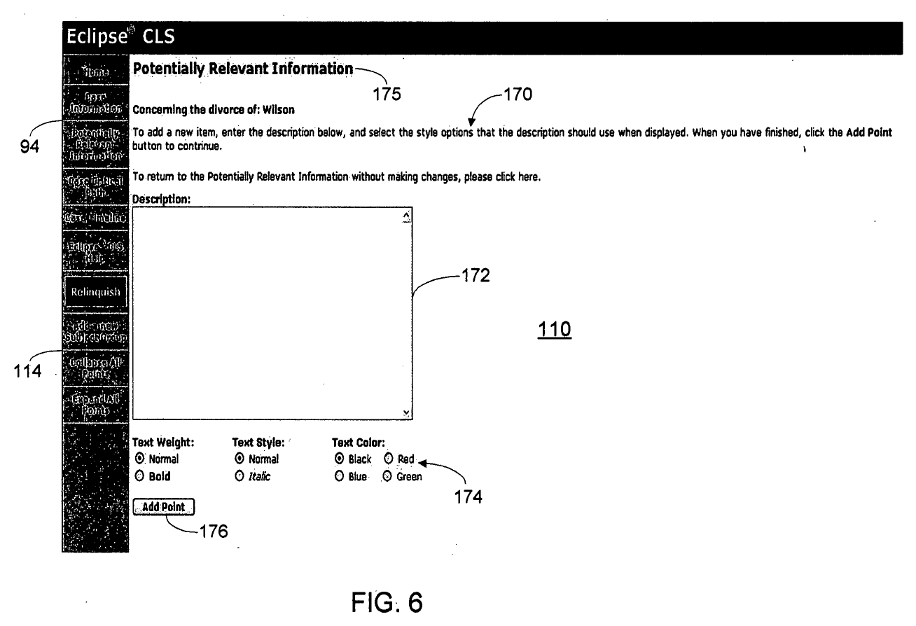

Referring now to FIG. 4, the Potentially Relevant Information page 90 includes another bank 94 of quick link buttons 60-65 along the left margin of the page and a large text viewing box 92 adopted for presenting factual information potentially relevant to the collaborative divorce proceeding. The information is preferably presented in an outline format of including topics and subtopics with supporting information that may be processed line by line with an array 96 of separate sets 98 of editing tools 100-106. The individual sets 98 of editing tools reside on the right border of the box 92 with one set of tools alongside each block of text. Upon being clicked the arrow buttons 100 and 101 allow the corresponding text block on their left to be moved one tab interval to the left or one tab interval to the right, respectively. Upon being clicked the arrow buttons 102 and 103 allow the corresponding text block on their left to be moved up one level within the outline or down one level within the outline, respectively. When the add button 104 is clicked a dialog window 110 (FIG. 6) is invoked which allows a sub-point to be added to the corresponding text block on the left. When the edit button 105 is clicked a dialog window 110 is invoked which allows the information in the corresponding text block on the left to be edited. When the delete button 106 is clicked a simple dialog box is invoked which prompts the user to confirm the deletion of text block to the left.

Additionally, the Potentially Relevant Information page 90 includes a bank 114 of extra buttons 120-123 providing miscellaneous functions positioned underneath the bank 94. When adding or editing text blocks the user has control over the text in the box 92 on page 90 but after editing can immediately relinquish such control to another user by clicking the relinquish button 120 to avoid having other users wait for a default time out period to elapse before allowing revisions by others after the first user ceases activity. When the add a new subject group button 121 is clicked a dialog window 110 is invoked that allows a new primary subject group and heading to be added to the outline in the text box 92. Upon being clicked the collapse points button 100 and expand points button 101 allow the primary subject points on the outline in the text box 92 to be collapsed or expanded depending on their current status, respectively. Individual subject points may be similarly collapsed or expanded by toggling the − and + symbols in the small squares along the left margin of the outline.

The Potentially Relevant Information page 90 and text box 92 may be initially filled in using one or more organizational templates offering typical factually related subject points of concern in divorces from which can help prompt the participants to fill in needed background information and data. Templates are however only suggestions as to what may be important in the proceedings and to how to organize and categorize the information with the actual outline being determined by the collective judgment of the participants. A preferred Potentially Relevant Information or PRI default template and a more complete PRI alternative template are shown below:

RRI Default Template

People
Children Of the Marriage
Children of other relationships
Extended family relevant info

Concerns—husband
Children
Assets/liabilities
Current income/liabilities

Concerns—wife
Children
Assets/liabilities
Current income/liabilities

Interests—husband

Interests—wife

Hot buttons—husband

Hot buttons—wife

Potential substantive issues

PRI Alternative Template

Circumstances of Marriage
Legally relevant circumstances
Individually relevant
Jointly relevant

Children
Of Marriage
Of other relationships

Assets
Real property
   Marital
   Post separation
Alternative listing
   Income
   Homestead
   Recreational
Personal property
   Pre marriage
      Husband
      Wife
   Marital
   Post separation
      Husband
      Wife
   Alternative listing
      Vehicles
      Bank accounts
      Investments

Liabilities
Pre marriage
   Husband
   Wife
Marital
   Consumer—
   Short term liabilities
   Long term liabilities
Post separation

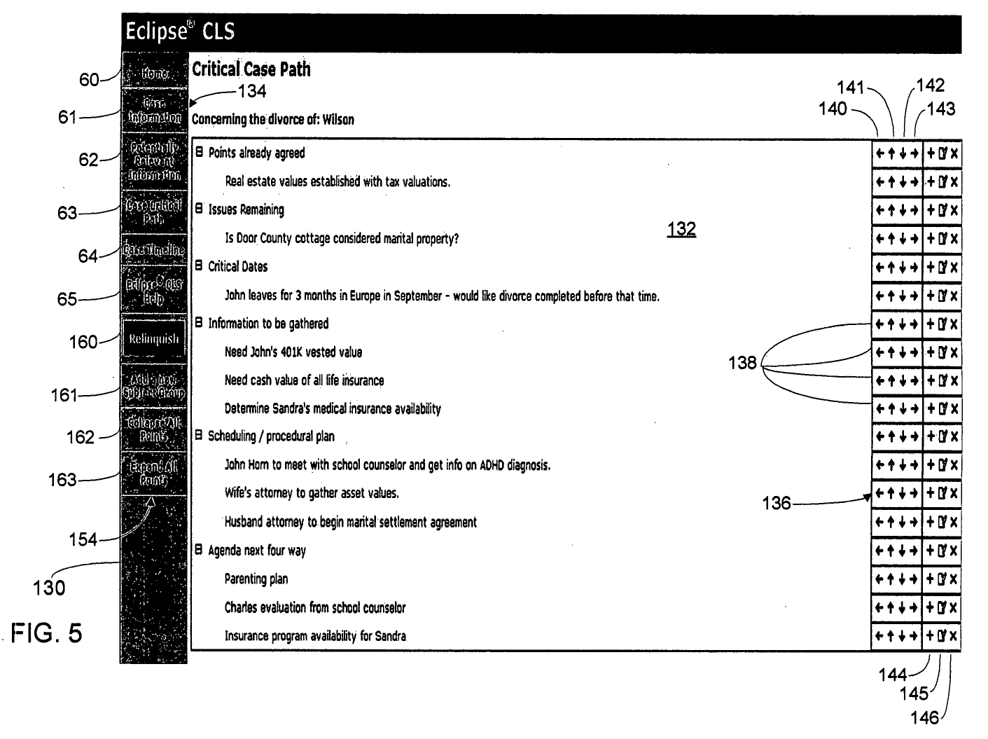

Referring now to FIG. 5, the Case Critical Path page 130 includes another bank 134 of quick link buttons 60-65 along the left margin of the page and a large text viewing box 132 adopted for presenting issues critical to the resolution of the collaborative divorce proceeding and procedures or proposed procedures for resolving those issues. The information is preferably presented in an outline format of including topics and subtopics with supporting information that may be processed line by line with an array 136 of separate sets 138 of editing tools 140-146. The individual sets 138 of editing tools reside on the right border of the box 132 with one set of tools alongside each block of text. Upon being clicked the arrow buttons 140 and 141 allow the corresponding text block on their left to be moved one tab interval to the left or one tab interval to the right, respectively. Upon being clicked the arrow buttons 142 and 143 allow the corresponding text block on their left to be moved up one level within the outline or down one level within the outline, respectively. When the add button 144 is clicked a dialog window 110 (FIG. 6) is invoked which allows a sub-point to be added to the corresponding text block on the left. When the edit button 145 is clicked a similar dialog window 110 is invoked which allows the information in the corresponding text block on the left to be edited. When the delete button 146 is clicked simple dialog box is invoked which prompts the user to confirm the deletion of text block to the left.

Additionally, Case Critical Path page 130 includes a bank 154 of extra buttons 160-163 providing miscellaneous functions positioned underneath the bank 134. When adding or editing text blocks the user has control over the text in the box 132 on page 130 but after editing can immediately relinquish such control to another user by clicking the relinquish button 160 to avoid having other users wait for a default time out period to elapse before allowing revisions by others after the first user ceases activity. When the add a new subject group button 161 is clicked a dialog window 110 is invoked that allows a new primary subject group and heading to be added to the outline in the text box 132. Upon being clicked the collapse points button 160 and expand points button 161 allow the primary subject points on the outline in the text box 132 to be collapsed or expanded depending on their current status, respectively. Individual subject points may be similarly collapsed or expanded by toggling the − and + symbols in the small squares along the left margin of the outline.

The Potentially Relevant Information page 130 and text box 132 may be initially filled in using one or more organizational templates offering typical issue related subject points of concern in divorces from which can help prompt the participants to identify issues, comment on issues and resolution procedures and fill in needed issue related background information. Templates are however only suggestions as to what may be important in the proceedings and to how to organize and categorize the issues and the procedures for their resolution with the actual outline being determined by the collective judgment of the participants. A preferred Case Critical Path or CCP default template and a more complete CCP alternative template are shown below:

CCP Default Template

Information to be gathered

Scheduling/procedural plan

Points already agreed

Issues Remaining

Agenda next 4 way

Critical dates

CCP Alternative Template

Areas of agreement
Assets
Liabilities
Children
   Visitation
   Daycare costs

Issues remaining
Children
Assets
Liabilities

Existing support issues
Husband
Wife
children

Sequence of resolution

Referring now to FIG. 6, the dialog window 110 fills the screen in place of the text viewing boxes 92 or 132 and their editing tools and includes some brief directions 170, a large text entry box 172 and a set 174 of radio buttons providing style options for dressing up the text. The dialog window 110 shows a different title 175 according to whether it was invoked from the Potentially Relevant Information or Case Critical Path pages. The dialog window 110 also takes slightly different forms depending on whether it is invoked for editing existing point (as shown in FIG. 6), adding a new item or adding a new subject group and the directions 170 change to instruct that existing text appearing in the test box 172 may be edited, that text comprising a new may be added may by added or that a new subgroup may be in the added depending on the process by which the dialog window 110 was invoked. The dialog window 110 also includes a action button 176 that may either bear the legend edit point or add point again depending on how the window was invoked and may be clicked to initiate the actual placement from the text box 170 of the edited text, the added item or the added subgroup into the outline in the text viewing boxes 92 or 132 of the Potentially Relevant Information or Case Critical Path pages as the case may be.

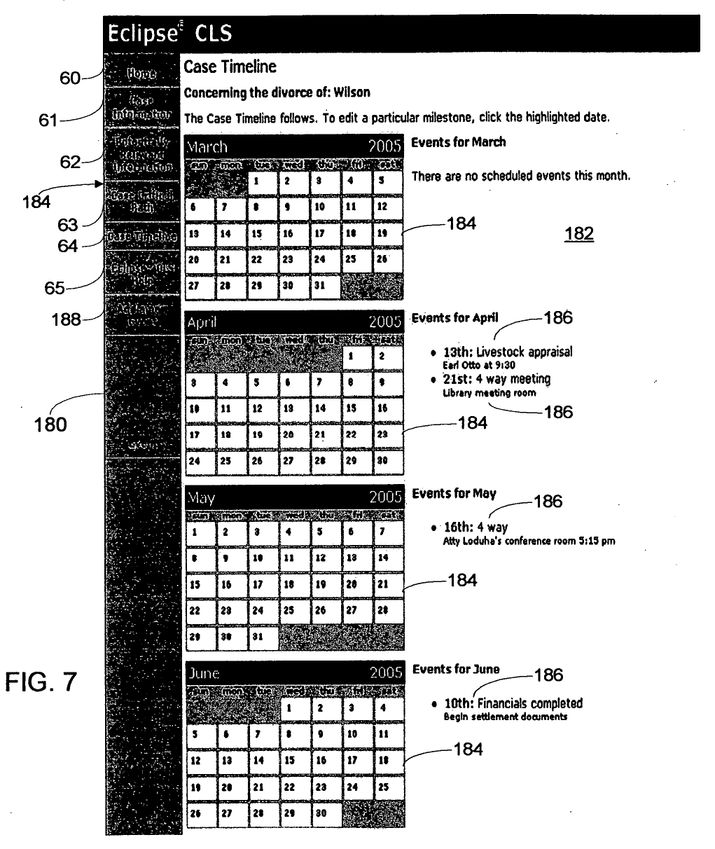

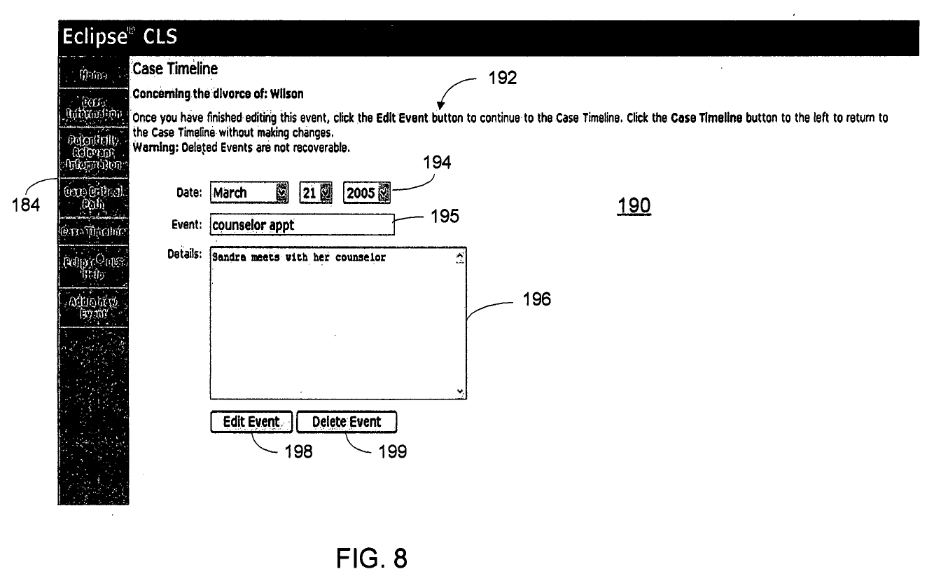

Referring now to FIG. 7, the Case Timeline page 180 includes another bank 184 of quick link buttons 60-65 along the left margin of the page and a case timeline 182 comprising a series of monthly calendars 184 presenting the individual days of each month in a square matrix with one week shown on each line. The days on which collaborative divorce events are scheduled to occur are highlighted in a different color and may have a different text style. The collaborative divorce events for each month are documented with short descriptions 186 that include the day, event title and event subject matter appearing along the right hand border of each month on the timeline 180. The day within each of the descriptions 186 constitutes a hot spot which can be clicked to invoke a dialog widow 190 (FIG. 8) for editing or deleting that event. The Case Timeline page 180 also includes a add a new event button 188 positioned underneath the bank 184 that invokes a similar dialog window 190 for adding an event to the case timeline 180.

Referring now to FIG. 8, the dialog window 190 fills the screen in place of the monthly calendars 184 and descriptions 186 and includes some brief directions 192, a set of date entry boxes 194, an event title entry box 195 and a large text entry box 196. The dialog window 190 takes slightly different forms depending on whether it is invoked for editing or deleting an event (as shown in FIG. 8) or adding a new event and the directions 192 change to instruct that existing event text appearing in the boxes 194-196 may be edited or deleted or that text comprising a new event may be added may by depending on the process by which the dialog window 190 was invoked. The dialog window 190 also includes two action buttons 198 and 199 (as shown) that bear the legends edit event or delete event or a single button in their place bearing the legend add this event again depending on how the window 190 was invoked and may be clicked to initiate the actual placement from the text from boxes 194-196 onto the timeline 180.

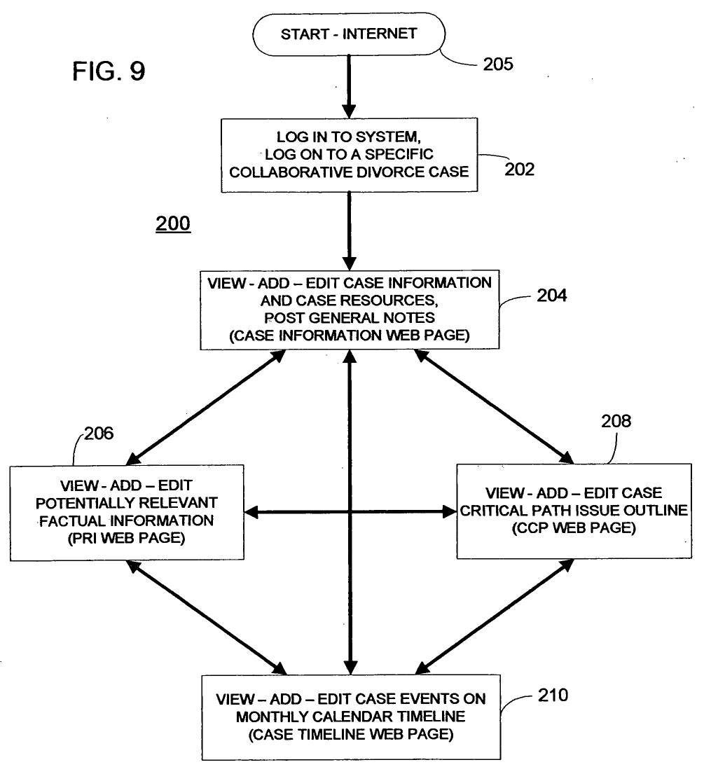

Referring now to FIG. 9, the flowchart 200 comprises step 205 in accordance with which a user of the collaborative divorce application 14 accesses the internet with a remote computer such as one of computers 20-25 and step 202 in which the user logs in to the collaborative divorce system and further provides a case password enabling entry into one of the divorce case files. Thereafter, in step 204 the user is transferred to the Case Information (web) page 50 and may enter information identifying new parties, lawyers or case resources as previously described. From the Case Information page 50 the user may use the quick link buttons 60-65 in the bank 52 to transfer to any of the steps 206, 208 or 210 representing the Potentially Relevant Information (web) page 90, the Case Critical Path (web) page 130 or Case Timeline (web) page 180. In step 206 at the Potentially Relevant Information page 90 the user may add or revise different types of factual information affecting the proceedings as previously described. In step 208 at the Case Critical Path page 130 the user may add or revise different types of issue information relating to the proceedings and procedures for resolving these issues as previously described. In step 210 at the Case Timeline page 180 the user may add or revise events affecting the proceedings as previously described. The user may use the quick link buttons 60-65 in any of the banks 52, 94, 134 or 184 to conveniently switch between the web pages representing the collaborative divorce application and steps 204, 206, 208 and 210 at any time. Moreover, the user has the ability to and is expected to add, revise and update information, issues, resolution procedures and events affecting the proceedings and iteratively evolve the information and data populating the application case file as the proceedings progress and can readily communicate all this information to the other participants on an expedited basis using the collaborative system established by the application. The participants are thereby enabled advance the progress of the case on a step-by-step basis using the application as an essential tool for administering, supporting and facilitating collaborative family law proceedings.

Although the present invention has been described with reference to the specific embodiments described above, it should be recognized that changes may be made in the form and details of the invention as described without departing from spirit of the invention or the scope of the claims.

1. A programmed system for providing an online internet-based application service in support of collaborative divorce proceedings, comprising:
a) an interactive introduction web page presentation for viewing and entering information identifying the divorce proceeding and the parties involved including a bulletin board for viewing and entering short messages;
b) an interactive information web page presentation for viewing and entering factual information relating to the divorce proceedings including the status of relationships and financial and property data;
c) an interactive critical path web page presentation for viewing and entering critical path information about the issues and procedures for resolving the issues; and
d) an interactive scheduling web page presentation including a calendar for viewing information about the timeline of events affecting the proceeding and for entering information about new events.

2. The system of claim 1, in which said information web page presentation includes:
an information template for organizing said factual information in subject categories.

3. The system of claim 2, in which said information template includes:
subject categories for other people involved, hot buttons for the wife, hot buttons for the husband, real property, personal property and financial liabilities.

4. The system of claim 1, in which said critical path web page presentation includes:
a critical path template including subject categories for highlighting remaining issues and providing event sequences to resolve them.

5. The system of claim 4, in which said critical path template further includes:
subject categories for information to be gathered, areas of agreement, and critical dates.

6. A process for use in conjunction with an online internet-based programmed application service for supporting collaborative divorce proceedings, comprising the steps of:
a) viewing and entering information identifying the divorce proceeding and the parties involved on a web page;
b) viewing and entering factual information relating to the divorce proceedings including the status of relationships and financial and property data on an interactive information web page presentation;
c) viewing and entering critical path information about the issues and procedures for resolving the issues on an interactive critical path web page; and
d) viewing a case calendar and entering information about the timeline of events affecting the proceeding on an interactive scheduling web page.

7. The process of claim 6, in which said step of viewing and entering information includes the step of:
viewing and entering short messages in a messaging window provided on an said interactive introduction web page.

8. The process of claim 6, in which said step of viewing and entering information includes the step of:
using an information template for organizing said factual information in subject categories.

9. The process of claim 6, in which said step of viewing and entering critical path information includes the step of:
using a template highlighting potential issues and providing procedures for the sequencing of events to resolve them.

10. A process for use in conjunction with an online internet-based programmed application service for supporting collaborative divorce proceedings, comprising the steps of:
a) engaging clients and their personal counselors for participation in a collaborative divorce proceeding including direct online interaction;
b) engaging the attorneys representing said clients for participation in a collaborative divorce proceeding including direct online interaction under the condition that they can not represent the same clients in the event the divorce becomes non-collaborative; and
c) conducting online collaborative negotiations based on interactive web page presentations of relevant information, including:
(i) viewing and entering potentially relevant factual information relating to the divorce proceedings including the status of relationships and financial and property data,
(ii) viewing and entering critical path information about critical path issues and designing resolution procedures for resolving these issues, and
(iii) executing a resolution process in accordance with the resolution procedures.

11. The process of claim 10, in which said step of conducting online collaborative negotiations includes the further sub-steps of:
(iv) revising critical path information about one or more critical path issues and redesigning revised procedures for resolving these issues, and
(v) re-executing the resolution process in accordance with the revised procedures.

12. The process of claim 11, in which said step of conducting online collaborative negotiations includes the further sub-steps of:
(iv) revising the potentially relevant factual information.

13. The process of claim 10, in which said step of conducting online collaborative negotiations includes the further sub-steps of:
(iv) viewing and entering information identifying the divorce proceeding and the parties involved,
(v) viewing a case calendar and entering information about the timeline of events affecting the proceeding.

14. The process of claim 13, in which said step of viewing and entering information includes the step of:
viewing and entering short messages in a messaging window provided on an said interactive introduction web page.

15. The process of claim 10, in which said sub-step of viewing and entering information includes the steps of:
using an information template for organizing said factual information in subject categories, and
using a template highlighting potential issues and providing procedures for a sequencing of events to resolve them.
